(19) United States
(12) Patent Application Publication
(10) Pub. No.: US 2020/0018525 A1
(43) Pub. Date: Jan. 16, 2020

(54) PLATE-SHAPED MAGNETIC WORK BODY AND MAGNETIC HEAT PUMP DEVICE USING SAME

(71) Applicant: SANDEN HOLDINGS CORPORATION, Isesaki-shi Gunma (JP)

(72) Inventors: Makoto TAKEDA, Isesaki-shi Gunma (JP); Takaaki UNO, Isesaki-shi Gunma (JP); Sangchul BAE, Isesaki-shi Gunma (JP); Yusuke YAMAGUCHI, Isesaki-shi Gunma (JP)

(21) Appl. No.: 16/494,164

(22) PCT Filed: Feb. 13, 2018
(86) PCT No.: PCT/JP2018/004814

§ 371 Date: Sep. 13, 2019

(30) Foreign Application Priority Data
Mar. 13, 2017 (JP) 2017-047423

(51) Int. Cl. F25B 21/00; F28F 3/04; H01F 1/01

(52) U.S. Cl. CPC F25B 21/00; F28F 3/048; H01F 1/012; F25B 2321/0023; F25B 2500/09; F25B 2321/0022; F25B 2321/001

(57) ABSTRACT

There are provided a magnetic work body capable of being easily laminated and a magnetic heat pump device using the same. A magnetic work body is provided with a plate-shaped body 31 formed of a magnetic work substance, in which a gap forming deformation portion 32 serving as a gap adjusting member in laminating is formed in the plate-shaped body.

### TECHNICAL FIELD

The present invention relates to a plate-shaped magnetic work body having a magnetocaloric effect and a magnetic heat pump device using the same.

### BACKGROUND ART

In place of a conventional vapor compression refrigerator using a gas medium, such as chlorofluorocarbon, a magnetic heat pump device utilizing a magnetocaloric effect which is a property that a magnetic work substance causes a large temperature change in magnetization and demagnetization has recently drawn attention.

The magnetic heat pump device is configured so that the magnetic work substance is disposed in a liquid medium flow passage to exchange heat with a heat medium by the magnetocaloric effect. Conventionally, the magnetic work substance is molded into a granular shape, the granular-shaped magnetic work substances are stored in a tubular case, and a liquid medium is circulated in the tubular case.

Thus, when the magnetic work substance is molded into a granular shape, while the contact surface area with the liquid medium can be increased, the flow passage resistance of the heat medium increases, which has posed a problem that efficient heat exchange cannot be performed.

Therefore, in order to reduce the flow passage resistance of the heat medium, magnetic work bodies described in PTLS 1 and 2 have been proposed.

In PTL 1, two modules in which a large number of blades are aligned in a comb shape in the cross section of a magnetic work substance are alternately combined so that the blades of one module are inserted between the blades of the other module, and a heat medium is passed through gaps formed between the blades.

In PTL 2, a thin band body is formed by a melt quenching method using a powder raw material, four thin band bodies are laminated to form a plate-shaped laminate, the laminate is cut, ground, polished, and the like to produce a material piece in which a groove extending in a depth direction with a 0.1 mm depth is formed in the main surface, the material pieces are heated, and then the material pieces which are made to absorb hydrogen are laminated to manufacture a heat exchanger serving as a microchannel.

### CITATION LIST

Patent Literature

PTL 1: JP 2015-524908 T

PTL 2: JP 2014-44003 A

### SUMMARY OF INVENTION

### Technical Problem

However, the conventional example described in PTL 1 described above has an unsolved problem that the two kinds of modules having the plurality of two kinds of blades are integrally molded by extrusion molding, and therefore, when the number, thickness, and the like of the blades are changed, extrusion molding dies need to be formed one by one, so that modules having an arbitrary number of blades cannot be easily formed at a low cost.

The conventional example described in PTL 2 described above has unsolved problems that the four thin band bodies are laminated to form the laminate, the laminate is cut, ground, polished, and the like while leaving both the side surface sides to form a material piece in which the groove serving as a heat medium flow passage is formed, and then the material pieces are laminated to thereby manufacture the heat exchanger serving as a microchannel, and therefore the manufacturing process becomes complicated and the material pieces cannot be easily formed because machining, such as cutting, grinding, and polishing, is involved.

Thus, the present invention has been made focusing on the unsolved problems of the conventional examples described in PTLS 1 and 2 described above. It is an object of the present invention to provide a plate-shaped magnetic work body capable of being easily laminated with space therebetween and a magnetic heat pump device using the same.

### Solution to Problem

In order to achieve the above-described object, one aspect of a plate-shaped magnetic work body according to the present invention is provided with a plate-shaped body formed of a magnetic work substance, in which a gap forming deformation portion serving as a gap adjusting member in laminating is formed in the plate-shaped body.

One aspect of a magnetic heat pump device according to the present invention is provided with a magnetic work body unit in which two or more of the above-described plate-shaped magnetic work bodies are laminated while maintaining a gap formed by the gap forming deformation portion in a vessel in which a heat medium is made to flow, a magnetic field changing mechanism configured to change the magnitude of a magnetic field applied to the magnetic work body of the magnetic work body unit, a heat medium moving mechanism configured to move the heat medium between a high temperature end and a low temperature end of the magnetic work body unit, a heat dissipation side heat exchanger configured to cause the heat medium on the high temperature end side to dissipate heat, and a heat absorption side heat exchanger configured to cause the heat medium on the low temperature end side to absorb heat.

### Advantageous Effects of Invention

According to one aspect of the present invention, the gap forming deformation portion serving as the gap adjusting member in laminating is formed in the plate-shaped magnetic work body, and therefore a path in which a heat medium passes can be easily formed by the gap forming deformation portion by laminating the plate-shaped magnetic work bodies as they are.

Moreover, a magnetic heat pump device with good heat exchange efficiency can be easily created with a simple configuration by laminating the plate-shaped magnetic work bodies having the above-described configuration to configure the magnetic work body unit.

### BRIEF DESCRIPTION OF DRAWINGS

FIG.1 is a schematic block diagram illustrating one embodiment of a magnetic heat pump device according to the present invention;

FIG. 2 is a cross-sectional view of a heat pump body of FIG. 1;

FIG. 3 is a cross-sectional view illustrating a magnetic work body unit of FIG. 1;

FIGS. 4A and 4B are perspective views illustrating a first embodiment of a plate-shaped magnetic work body;

FIG. 5 is a characteristic diagram illustrating the relationship between the temperature of a magnetic work substance and an entropy change;

FIG. 6 is a characteristic diagram illustrating the temperatures of a high temperature end and a low temperature end of the magnetic work body in a state where a temperature change is saturated;

FIGS. 7A and 7B are cross-sectional views illustrating a modification of the first embodiment;

FIG. 8 is a cross-sectional view illustrating a second embodiment of the magnetic work body unit;

FIG. 9 is a cross-sectional view illustrating a second embodiment of the plate-shaped magnetic work body;

FIG. 10 is a cross-sectional view illustrating a modification of the magnetic work body unit of the second embodiment;

FIG. 11 is a cross-sectional view illustrating a plate-shaped magnetic work body of FIG. 10;

FIG. 12 is a perspective view illustrating another example of a heat pump body; and

FIG. 13 is a perspective view illustrating a still another example of a heat pump body.

### DESCRIPTION OF EMBODIMENTS

Next, one embodiment of the present invention is described with reference to the drawings. In the following description of the drawings, the same or similar portions are designated by the same or similar reference numerals. However, it should be noted that the drawings are schematic and the relationship between the thickness and the plane dimension, the ratio in thickness of each layer, and the like are different from actual relationship, ratio, and the like. Therefore, specific thickness and dimension should be determined considering the following description. It is a matter of course that the drawings also include portions having dimensional relationships and ratios different from each other.

Moreover, the embodiments described below illustrate devices or methods for embodying the technological idea of the present invention and the technological idea of the present invention does not specify materials, shapes, structures, arrangement, and the like of constituent components to the materials, shapes, structures, arrangement, and the like described below. The technological idea of the present invention can be variously altered in the technological scope specified by Claims described in Claims.

### First Embodiment

First, one embodiment of a magnetic heat pump device illustrating a first aspect of the present invention is described.

### [Configuration of Magnetic Heat Pump Device]

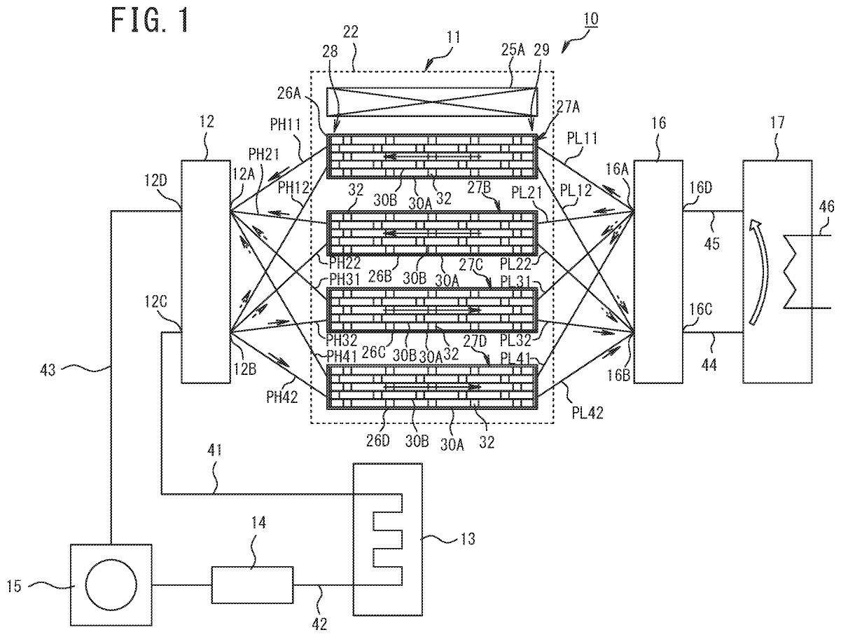

A magnetic heat pump device 10 is provided with a heat pump body 11, a high temperature side switching valve 12, a heat dissipation side heat exchanger 13, a heater 14, a circulating pump 15, a low temperature side switching valve 16, and a heat absorption side heat exchanger 17 as illustrated in FIG. 1.

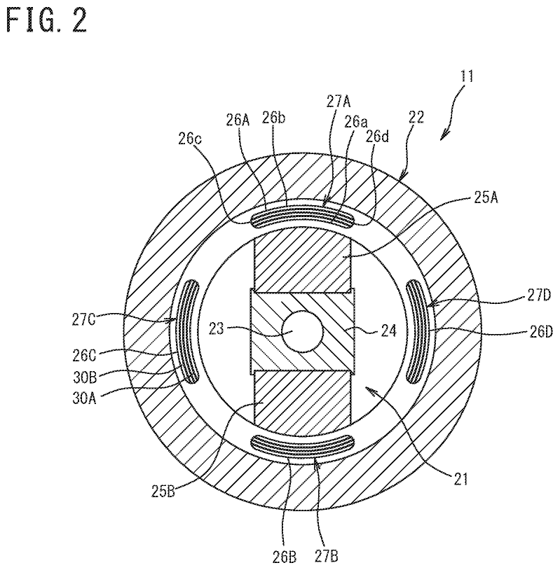

The heat pump body 11 configures a heat pump AMR (Active Magnetic Regenerator). The heat pump body 11 is provided with a rotor 21 coupled to a servomotor which is not illustrated through a decelerator and rotationally driven in one direction and a stator 22 as a cylindrical fixing portion containing a cylindrical case body surrounding the circumference of the rotor 21 as illustrated in FIG. 2.

The rotor 21 is provided with a rectangular parallelepiped-shaped support member 24 fixed to a rotation shaft 23 and extending in the axial direction and a pair of permanent magnets 25A and 25B serving as magnetic field generating members fixed onto the long sides facing each other of the support member 24 and extending in the radial direction and the axial direction. The permanent magnets 25A and 25B each have a wide shape and the tip on the outer peripheral side is formed into a cylindrical shape centering on the center of the rotation shaft 23.

On the inner peripheral surface of the stator 22, four hollow ducts 26A, 26B and 26C, 26D in total, two hollow ducts of which face each other across the center at the top and bottom positions and the right and left positions, for example, are disposed at intervals of 90° in the circumferential direction extending in the axial direction of the stator 22 so as to face the outer peripheral surfaces of the permanent magnets 25A and 25B. The hollow ducts 26A to 26D each are formed of a high heat insulating resin material. This reduces heat loss to the outside of a magnetic work body having a magnetocaloric effect described later and prevents heat transfer to the rotation shaft 23 side.

The hollow ducts 26A to 26D each are formed into a flat circular-arc oblong shape by an inner cylindrical surface 26a centering on the center of the rotation shaft 23, an outer cylindrical surface 26b centering on the center of the rotation shaft 23, and circular-arc-shaped side surface portions 26c and 26d individually coupling both end portions of the inner cylindrical surface 26a and the outer cylindrical surface 26b and the length in the circumferential direction is selected to be substantially equal to the lengths in the circumferential direction of the permanent magnets 25A and 25B.

In the hollow ducts 26A to 26D, magnetic work body units 27A to 27D exhibiting the magnetocaloric effect which is a property of causing a large temperature change in magnetization and demagnetization are disposed.

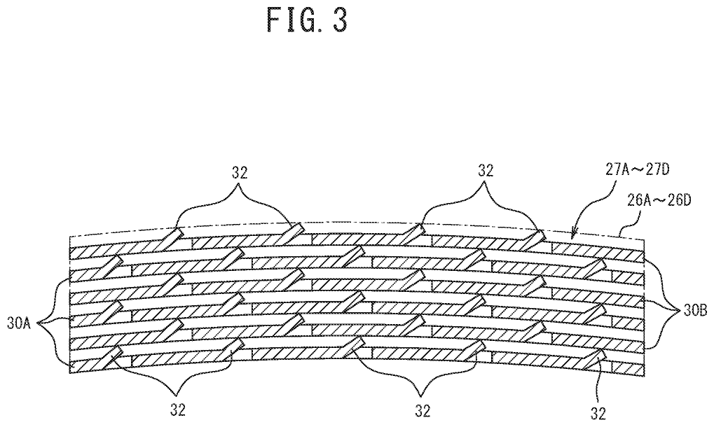

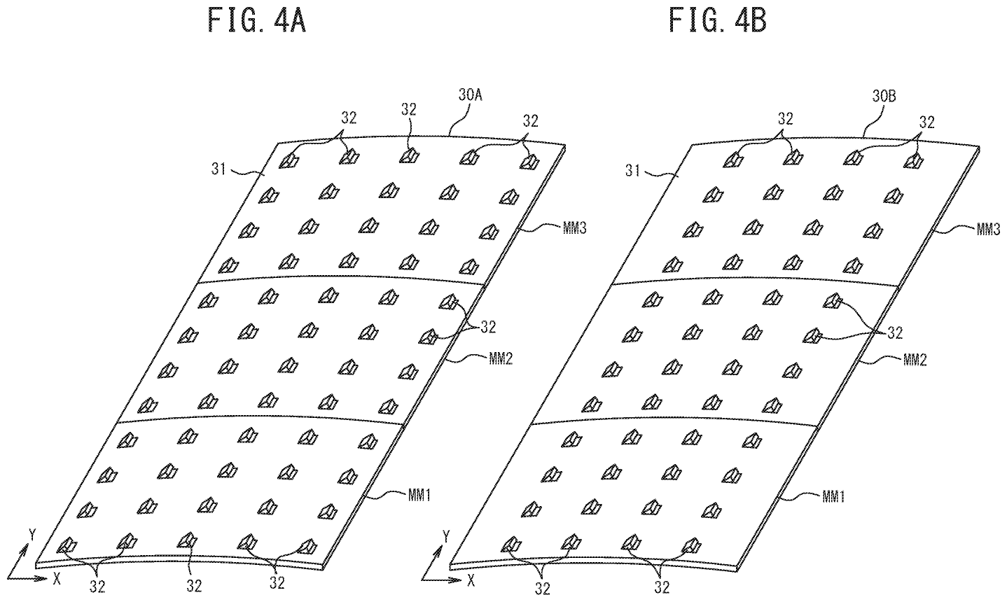

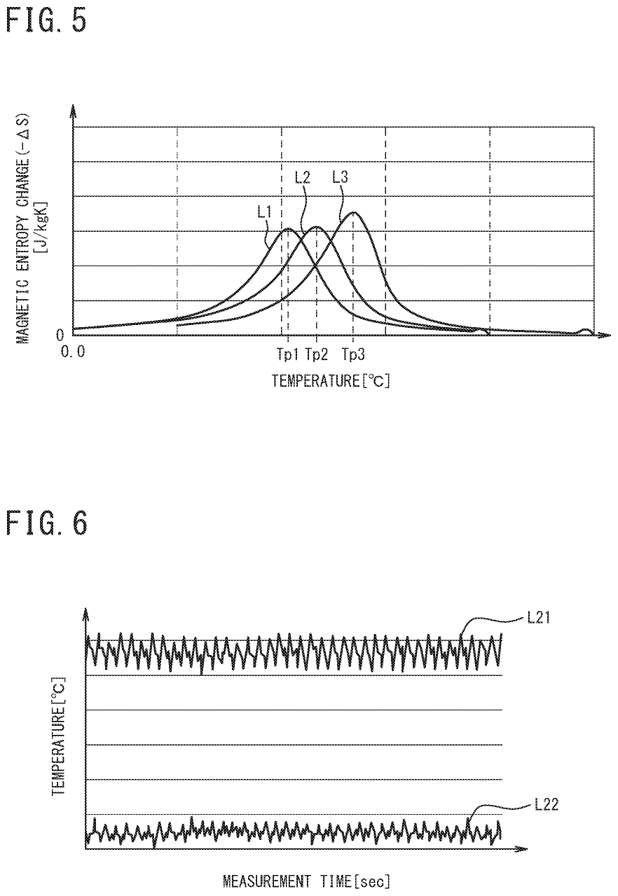

The magnetic work body units 27A to 27D each are configured by laminating a plurality of two kinds of first magnetic work bodies 30A and second magnetic work bodies 30B formed of a magnetic work substance exhibiting the magnetocaloric effect in the radial direction as illustrated in FIGS. 3 and 4.

Herein, with respect to the first magnetic work body 30A, a plate-shaped body 31 is formed with a thickness of 1 mm having the same circular-arc-shaped cross section and the same circumferential length as those of the hollow ducts 26A to 26D, for example, using a powder raw material of the magnetic work substance by a melt quenching method as illustrated in FIG. 4A. At this time, it is preferable to form cut and raised grooves at the positions where cut and raised pieces are to be formed of the plate-shaped body 31. However, the cut and raised grooves may be formed after the formation of the plate-shaped body 31.

Then, the plate-shaped body 31 is pressed with a pressing machine to thereby cut and raise the plate-shaped body 31 in the circumferential direction to form two or more of the cut and raised pieces 32 serving as gap forming deformation portions. Herein, two or more, e.g., three or more, of the cut and raised pieces 32 are individually formed while maintaining a predetermined interval in a longitudinal direction X and a width direction Y so as not to cause bending in the plate-shaped bodies 31 to be supported when laminated. All the cut and raised directions of the cut and raised pieces 32 are made the same. The length and the angle are selected according to gaps required for forming heat medium passages in laminating. The width is selected according to the load of the plate-shaped bodies to be supported.

The cut and raised pieces 32 of the first magnetic work body 30A are formed to be aligned at equal intervals in the axial direction on a plurality of straight lines having equal intervals in the circumferential direction, i.e., the width direction X, and extending in the axial direction, i.e., the longitudinal direction Y, of the ducts 26A to 26D as illustrated in FIG. 4A.

The second magnetic work body 30B has the same configuration as that of the first magnetic work body 30A except that the cut and raised pieces 32 are formed at intermediate positions, for example, between the cut and raised pieces 32 in the width direction of the first magnetic work body 30A so as not to overlap with the cut and raised pieces 32 of the first magnetic work body 30A as viewed in plan as illustrated in FIG. 4B.

The installation number of the cut and raised pieces 32 can be arbitrarily set. When the rigidity of the plate-shaped body 31 is high, at least three cut and raised pieces 32 each capable of supporting three points maybe formed at different positions between the first magnetic work body 30A and the second magnetic work body 30B in the first magnetic work body 30A and the second magnetic work body 30B.

The plate-shaped body 31 is preferably configured by arranging two or more of the magnetic work substances, e.g., three magnetic work substances of a first magnetic work substance MM1, a second magnetic work substance MM2, and a third magnetic work substance MM3, different in a temperature zone where a high magnetocaloric effect is exhibited in the longitudinal direction so that the temperature zone becomes higher in order, for example, as illustrated in FIGS. 4A and 4B. As one example, those in which the relationships between a temperature T and an entropy change (−ΔS) [J/kg·K] are illustrated in FIG. 5 are selected as the three magnetic work substances MM1 to MM3.

More specifically, for the first magnetic work substance MM1, an Mn-based material or a La-based material having a chevron-shaped characteristic in which the entropy change (−ΔS) reaches the peak at a temperature Tp1 around the lowest Curie point as illustrated by a characteristic curve L1 of FIG. 5 is used. For the second magnetic work substance MM2, an Mn-based material or a La-based material having a chevron-shaped characteristic in which the entropy change (−ΔS) reaches the peak at a temperature Tp2 around the Curie point higher than that of the first magnetic work substance MM1 as illustrated by a characteristic curve L2 of FIG. 5 is used. For the third magnetic work substance MM3, an Mn-based material or a La-based material having a chevron-shaped characteristic in which the entropy change (−ΔS) reaches the peak at a temperature Tp3 around the Curie point higher than that of the second magnetic work substance MM2 is used.

The Mn-based material or the La-based material has a larger magnetic entropy change (−ΔS) by magnetization/demagnetization and also higher heat absorption/heat dissipation capacity as compared with those of a conventionally used Gd-based material. However, an operation temperature zone (driving temperature span) where the high magnetocaloric effect of each material is exhibited is narrower than that of the Gd-based material. Therefore, when used alone, the temperature cannot be changed from normal temperature to a required freezing/heat dissipation temperature (hot-water supply or the like).

Therefore, by disposing the first magnetic work substance MM1, the second magnetic work substance MM2, and the third magnetic work substance MM3 side by side in the longitudinal direction of the plate-shaped body 31, a high magnetocaloric effect can be obtained in a required temperature range.

Then, the first magnetic work bodies 30A and the second magnetic work bodies 30B are alternately laminated in the radial direction in the hollow ducts 26A to 26D, whereby the magnetic work body units 27A to 27D are configured as illustrated in FIG. 3. At this time, a heat medium containing water, for example, is passed in the width direction of the cut and raised pieces 32 of each of the magnetic work bodies 30A and 30B, whereby the heat medium can be smoothly passed while reducing the flow passage resistance without the cut and raised pieces 32 hindering the passage of the heat medium.

In the magnetic work body units 27A to 27D, the first magnetic work bodies 30A and the second magnetic work bodies 30B may be just laminated. However, when the magnetic work bodies 30A and 30B are surely fixed, joining plates are joined to the side surfaces in the circumferential direction facing the circular-arc-shaped side surface portions 26c and 26d of the hollow ducts 26A to 26D by a joining means, such as blazing.

Then, high temperature pipes PH11, PH12 are connected to a high temperature end 28 of the hollow duct 26A of the heat pump body 11 having the above-described configuration and high temperature pipes PH21, PH22 are connected to a high temperature end 28 of the hollow duct 26B located at an axisymmetric position to the hollow duct 26A as illustrated in FIG. 1. High temperature pipes PH31, PH32 are connected to a high temperature end 28 of the hollow duct 26C and high temperature pipes PH41, PH42 are connected to a high temperature end 28 of the hollow duct 26D located at an axisymmetric position to the hollow duct 26C.

Similarly, low temperature pipes PL11, PL12 are connected to a low temperature end 29 of the hollow duct 26A and low temperature pipes PL21, PL22 are connected to a low temperature end 29 of the hollow duct 26B located at an axisymmetric position to the hollow duct 26A. Low temperature pipes PL31, PL32 are connected to a low temperature end 29 of the hollow duct 26C and low temperature pipes PL41, PL42 are connected to a low temperature end 29 of the hollow duct 26D located at an axisymmetric position to the hollow duct 26C.

The high temperature side switching valve 12 contains a rotary valve, an electromagnetic valve, a poppet valve, and the like, for example, and switched and controlled with the rotation of the rotor 21. The high temperature side switching valve 12 is provided with connection ports 12A and 12B connected to the hollow ducts 26A to 26D, an outflow port 12C connected to an inlet of the heat dissipation side heat exchanger 13, and an inflow port 12D connected to a discharge side of the circulating pump 15. The high temperature side switching valve 12 is switched to a state of causing the connection port 12A to communicate with the outflow port 12C synchronizing with the rotation of the rotor 21 described above and causing the connection port 12B to communicate with the inflow port 12D and a state of causing the connection port 12A to communicate with the inflow port 12D and causing the connection port 12B to communicate with the outflow port 12C.

To the connection port 12A, the high temperature pipes PH11 to PH41 drawn out from the heat pump body 11 are connected. To the connection port 12B, the high temperature pipes PH12 to PH42 drawn out from the heat pump body 11 are connected.

The outflow port 12C of the high temperature side switching valve 12 is connected to the inlet of the heat dissipation side heat exchanger 13 through a pipe 41 and an outlet of the heat dissipation side heat exchanger 13 is connected to the suction side of the circulating pump 15 through a pipe 42 and the heater 14 disposed in the middle of the pipe 42. The discharge side of the circulating pump 15 is connected to the inflow port 12D of the high temperature side switching valve 12 through a pipe 43, so that a circulation path on the heat dissipation side is configured.

The low temperature side switching valve 16 contains a rotary valve, an electromagnetic valve, a poppet valve, and the like, for example, and switched and controlled with the rotation of the rotor 21 as with the high temperature side switching valve 12 described above. The low temperature side switching valve 16 is provided with connection ports 16A and 16B connected to the hollow ducts 26A to 26D and an outflow port 16C and an inflow port 16D connected to the heat absorption side heat exchanger 17.

To the connection port 16A, the low temperature pipes PL11 to PL41 drawn out from the heat pump body 11 are connected. To the connection port 16B, the low temperature pipes PL12 to PL42 drawn out from the heat pump body 11 are connected. The outflow port 16C is connected to an inlet of the heat absorption side heat exchanger 17 through a pipe 44 and the inflow port 16D is connected to an outlet of the heat absorption side heat exchanger 17 through a pipe 45, so that a circulation path on the heat absorption side is configured.

Then, the low temperature side switching valve 16 is switched to a state of causing the connection port 16A to communicate with the outflow port 16C synchronizing with the rotation of the rotor 21 described above and causing the connection port 16B to communicate with the inflow port 16D and a state of causing the connection port 16A to communicate with the inflow port 16D and causing the connection port 16B to communicate with the outflow port 16C.

The circulating pump 15, the high temperature side switching valve 12, the low temperature side switching valve 16, and the pipes configure a heat medium moving mechanism of reciprocating a heat medium between the high temperature end 28 and the low temperature end 29 of each of the magnetic work body units 27A to 27D.

### [Operation of Magnetic Heat Pump Device 10]

Next, the operation of the magnetic heat pump device 10 having the above-described configuration is described.

First, when the rotor 21 of the heat pump body 11 is located at a 0° position (position illustrated in FIG. 2), the permanent magnets 25A and 25B are located at 0° and 180° positions. Therefore, the magnitude of magnetic fields applied to the magnetic work body units 27A, 27B at the 0° and 180° positions increases, so that the magnetic work body units 27A, 27B are magnetized and the temperature increases.

On the other hand, the magnitude of magnetic fields applied to the magnetic work body units 27C, 27D located at 90° and 270° positions having a phase different therefrom by 90° decreases, so that the magnetic work body units 27C, 27D are demagnetized and the temperature decreases.

When the rotor 21 is located at the 0° position (FIG. 2), the high temperature side switching valve 12 causes the connection port 12A to communicate with the outflow port 12C and causes the connection port 12B to communicate with the inflow port 12D and the low temperature side switching valve 16 causes the connection port 16A to communicate with the inflow port 16D and causes the connection port 16B to communicate with the outflow port 16C.

By the operation of the circulating pump 15, a heat medium (water) is brought into a state of being circulated as indicated by the solid line arrows in FIG. 1 in the order of the circulating pump 15 → the pipe 43 → from the inflow port 12D to the connection port 12B of the high temperature side switching valve 12 → the high temperature pipes PH32 and PH42 → the magnetic work body units 27B and 27D at the 90° and 270° positions → the low temperature pipes PL32 and PL42 → from the connection port 16B to the outflow port 16C of the low temperature side switching valve 16 → the pipe 44 → the heat absorption side heat exchanger 17 → the pipe 45 — from the inflow port 16D to the connection port 16A of the low temperature side switching valve 16 → the low temperature pipes PL11 and PL21 → the magnetic work body units 27A and 27B at the 0° and 180° positions → the high temperature pipes PH11 and PH21 → from the connection port 12A to the outflow port 12C of the high temperature side switching valve 12 → the pipe 41 → the heat dissipation side heat exchanger 13 → the pipe 42 → the heater 14 → the circulating pump 15.

The heat medium (water) in the magnetic work body units 27A, 27B vibrates in the axial direction of the magnetic work body units 27A, 27B to transmit the heat from the low temperature end 29 to the high temperature end 28, the heat medium (water), the temperature of which has become high at the high temperature end 28, flows out of the high temperature pipes into the heat dissipation side heat exchanger 13 to release the amount of heat corresponding to the work to the outside (open air and the like), and then the heat medium (water), the temperature of which has become low at the low temperature end 29, flows out of the low temperature pipes into the heat absorption side heat exchanger 17 to absorb heat from a body 46 to be cooled to cool the body 46 to be cooled.

More specifically, the heat medium (water) which is cooled by dissipating heat to the magnetic work body units 27C and 27D, the temperature of which has decreased by being demagnetized, absorbs heat from the body 46 to be cooled in the heat absorption side heat exchanger 17 to cool the body 46 to be cooled. Thereafter, the heat medium (water) absorbs heat from the magnetic work body units 27A, 27B, the temperature of which has increased by being magnetized, to cool the same, returns to the heat dissipation side heat exchanger 13, and then releases the amount of heat corresponding to the work to the outside (open air and the like).

Next, when the rotor 21 is rotated by 90° with the permanent magnets 25A, 25B, the magnetic work body units 27A, 27B located at the 0° and 180° positions are demagnetized and the temperature decreases and the magnetic work body units 27C, 27D located at the 90° and 270° positions are magnetized and the temperature increases. At this time, when the high temperature side switching valve 12 contains a rotary valve, a valve body thereof is rotated by 90° with the rotor 21. Therefore, the heat medium (water) is next brought into a state of being circulated as indicated by the dotted line arrows in FIG. 1 in the order of the circulating pump 15 → the pipe 43 → from the inflow port 12D to the connection port 12B of the high temperature side switching valve 12 → the high temperature pipes PH12 and PH22 → the magnetic work body units 27A and 27B at the 0° and 180° positions → the low temperature pipes PL12 and PL22 → from the connection port 16B to the outflow port 16C of the low temperature side switching valve 16 → the pipe 44 → the heat absorption side heat exchanger 17 → the pipe 45 → from the inflow port 16D to the connection port 16A of the low temperature side switching valve 16 → the low temperature pipes PL31 and PL41 → the magnetic work body units 27C and 27D at the 90° and 270° positions → the high temperature pipes PH31 and PH41 → from the connection port 12A to the outflow port 12C of the high temperature side switching valve 12 → the pipe 41 → the heat dissipation side heat exchanger 13 → the pipe 42 → the heater 14 → the circulating pump 15.

The rotation of the rotor 21 and the switching of the high temperature side switching valve 12 and the low temperature side switching valve 16 are performed at the number of relatively high speed rotations and relatively high speed timing, the heat medium (water) is reciprocated between the high temperature end 28 and the low temperature end 29 of each of the magnetic work body units 27A to 27D, and the heat absorption/heat dissipation from each of the magnetic work body units 27A to 27D to be magnetized/demagnetized is repeated, whereby a temperature difference between the high temperature end 28 and the low temperature end 29 of each of the magnetic work body units 27A to 27D gradually increases. After a while, the temperature of the low temperature end 29 of each of the magnetic work body units 27A to 27D connected to the heat absorption side heat exchanger 17 decreases to a temperature at which the refrigerating capacities of the magnetic work body units 27A to 27D and the heat load of the body 46 to be cooled are balanced, so that the temperature of the high temperature end 28 of each of the magnetic work body units 27A to 27D connected to the heat dissipation side heat exchanger 13 becomes a substantially constant temperature because the heat dissipation capacity and the refrigerating capacity of the heat dissipation side heat exchanger 13 are balanced.

As described above, when the temperature difference between the high temperature end 28 and the low temperature end 29 of each of the magnetic work body units 27A to 27D increases by the repetition of the heat absorption/heat dissipation to reach a temperature difference balanced with the capacity of the magnetic work substances, the temperature change is saturated. Herein, FIG. 5 illustrates the temperatures of the high temperature end 28 and the low temperature end 29 in the state where the temperature change is saturated as described above by L21 and L22. As is clarified also from the figure, both the high temperature end 28 and the low temperature end 29 are affected by the heat absorption and the heat dissipation by the magnetization and the demagnetization and the temperature fluctuates with a predetermined temperature width (about 2 K in Examples).

Both or either one of the heat dissipation side heat exchanger 13 and the heat absorption side heat exchanger 17 contains a microchannel heat exchanger in Examples so that heat can be exchanged with the outside (open air or the body 46 to be cooled) with such a small temperature difference. The microchannel heat exchanger has a higher heat transfer coefficient and also a larger heat transfer area per unit volume as compared with those of heat exchangers of the other types, and thus is very suitable for obtaining required capacities by the magnetic heat pump device 10 as in the present invention.

The heat medium supplied to the high temperature end 28 or the low temperature end 29 of each of the magnetic work body units 27A to 27D flows into the low temperature end 29 side from the high temperature end 28 or into the high temperature end 28 side from the low temperature end 29 through the heat medium passages formed by the gaps between the laminated magnetic work bodies 30A and 30B. At this time, since the heat medium passages configured from the gaps are linearly formed in the axial direction, the flow passage resistance is low and the pressure loss decreases.

At this time, the cut and raised direction of the cut and raised pieces 32 of the magnetic work bodies 30A and 30B is the circumferential direction and the width direction is directed along the flowing direction of the heat medium, and therefore the cut and raised pieces 32 do not hinder the flow of the heat medium. Moreover, the heat transfer area with the heat medium can be expanded by the cut and raised pieces 32 as compared with a case of not providing the cut and raised pieces 32. Therefore, good heat exchange can be performed between the magnetic work body units 27A to 27D and the heat medium.

Furthermore, the cut and raised pieces 32 of the magnetic work bodies 30A and 30B are aligned in the longitudinal direction, i.e., the heat medium flowing direction, and therefore the flow passage cross-sectional area does not vary.

Moreover, when the magnetic work bodies 30A and 30B are formed, machining, such as cutting, grinding, and polish, is not required, and therefore chips are hardly generated and an expensive magnetic work substance can be effectively used.

Moreover, in order to adjust the gaps between the magnetic work bodies 30A and 30B of the magnetic work body units 27A to 27D, the length and the cut and raised angle of the cut and raised pieces 32 are adjusted, so that the gaps can be arbitrarily adjusted.

Thus, according to the first embodiment, the cut and raised pieces 32 are formed in the magnetic work bodies 30A and 30B, and therefore the heat medium flow passages of a predetermined gap can be formed only by alternately laminating the magnetic work bodies 30A and 30B and the magnetic work body units 27A to 27D can be manufactured with ease and at a low cost.

Accordingly, the heat pump body 11 containing the magnetic work body units 27A to 27D can be created with ease and at a low cost, and further the entire magnetic heat pump device 10 can be created with ease and at a low cost.

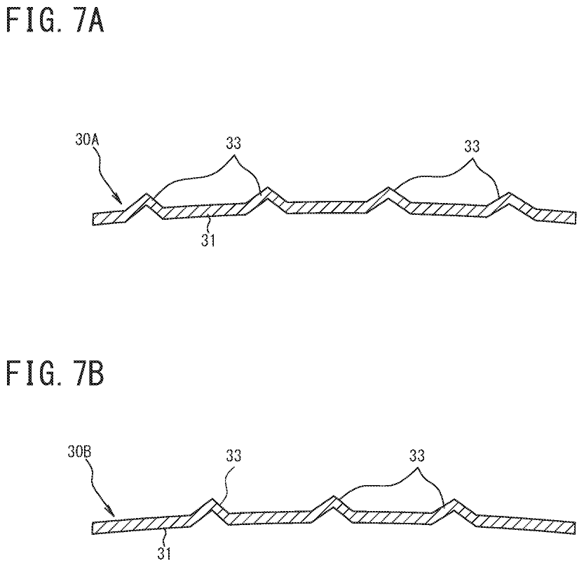

Although the above-described first embodiment describes the case where the gap adjusting deformation portions are configured from the cut and raised pieces 32 but are not limited thereto. As illustrated in FIGS. 7A and 7B, a plurality of bent portions 33 may be formed in the circumferential direction along the heat medium flowing direction by press processing in the plate-shaped body 31 and the bent portions 33 may be used as the gap adjusting deformation portions. In this case, the bent portions 33 can be formed into a circular-arc shape or a square shape without being limited to the case of being formed into an inverted V-shape as illustrated in FIGS. 7A and 7B. In short, the bent portions 33 may be projected from the plate surface of the plate-shaped body 31 so that the gaps can be adjusted.

Moreover, although the above-described first embodiment describes the case of using the two kinds of magnetic work bodies 30A and 30B but are not limited thereto and three or more kinds of magnetic work bodies in which the gap adjusting deformation portions are formed at different positions are also usable. Furthermore, in both end portions in the width direction or in the longitudinal direction, the formation starting position of the gap adjusting deformation portion of one end portion and the formation starting position of the gap adjusting deformation portion of the other end portion are differentiated from each other, whereby a magnetic work body unit can be configured by laminating one kind of magnetic work bodies while successively rotating the same by 180° as viewed in plan.

Moreover, the number of the gap adjusting deformation portions maybe 3 or 4 or more insofar as magnetic work bodies can be supported.

### Second Embodiment

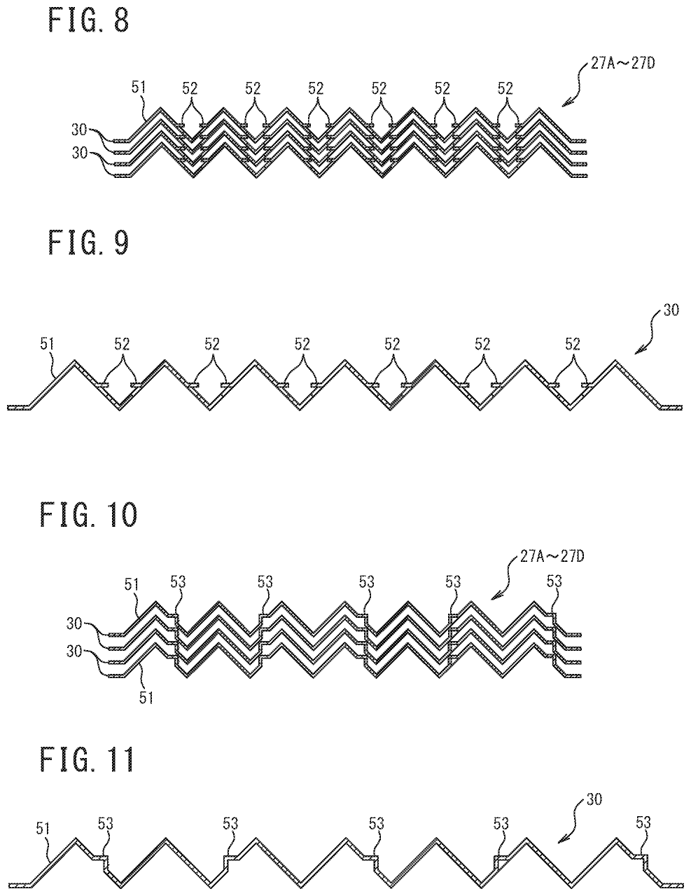

Next, a second embodiment of a magnetic work body according to the present invention is described with reference to FIGS. 8 and 9.

This second embodiment is configured to further expand the heat transfer area of a magnetic work body.

More specifically, in the second embodiment, a magnetic work body 30 is configured by laminating bent bodies 51 bent into a triangular wave shape as illustrated in FIGS. 8 and 9 in place of the plate-shaped bodies 31. As illustrated in FIG. 9, cut and raised pieces 52 are formed to face each other in the inclined surfaces in the bent body 51.

Then, the magnetic work bodies 30 are laminated as they are as illustrated in FIG. 8, whereby the adjacent magnetic work bodies 30 can be supported by the cut and raised pieces 52, so that the magnetic work body units 27A to 27D in which gaps are formed can be configured.

The other configurations have the same configurations as those of the first embodiment described above and the corresponding portions are designated by the same reference numerals and a detailed description thereof is omitted.

According to this second embodiment, a plate-shaped body configuring the magnetic work body 30 is configured from the bent body 41, and therefore the heat transfer area of the magnetic work body 30 can be expanded and the magnetocaloric effect can also be improved as compared with those of the first embodiment described above.

Moreover, the cut and raised pieces 52 are formed in the inclined surfaces of the bent body 51, whereby a magnetic work body unit can be configured by only laminating one kind of magnetic work bodies 30. Therefore, the magnetic work body unit can be manufactured at a lower cost.

Also in the second embodiment, bent portions 53 formed by press processing may be formed in the inclined surfaces of the bent body 51 as illustrated in FIGS. 10 and 11 in place of the cut and raised pieces 52 serving as the gap adjusting deformation portions. In this case, since the rigidity of the bent portions 53 is high, the bent portions 53 can be formed in at least every other facing inclined surfaces instead of providing the bent portions 53 in all the inclined surfaces. It is a matter of course that the bent portions 53 may be provided in all the facing inclined surfaces.

Moreover, the above-described first and second embodiments describe the case where the hollow ducts 26A to 26D in which the magnetic work body units 27A to 27D are disposed, respectively, are provided in the stator 22 but are not limited thereto and the number of hollow ducts in which the magnetic work bodies are disposed can be set to an arbitrary number and the number of permanent magnets disposed on the rotor 21 can also be arbitrarily set. In short, the number of magnetic work bodies in a magnetized state and the number of magnetic work bodies in a demagnetized state may be equal to each other.

The above-described first and second embodiments describe the case where the plate-shaped body 31 serving as the single magnetic work body contains the three magnetic work substances different in the temperature zone where a high magnetocaloric effect is exhibited but are not limited thereto and the plate-shaped body 31 may contain four or more magnetic work substances.

Moreover, the above-described first and second embodiments describe the case where the magnetic heat pump device is configured into an inner rotor type but are not limited thereto and the magnetic heat pump device can also be configured into an outer rotor type.

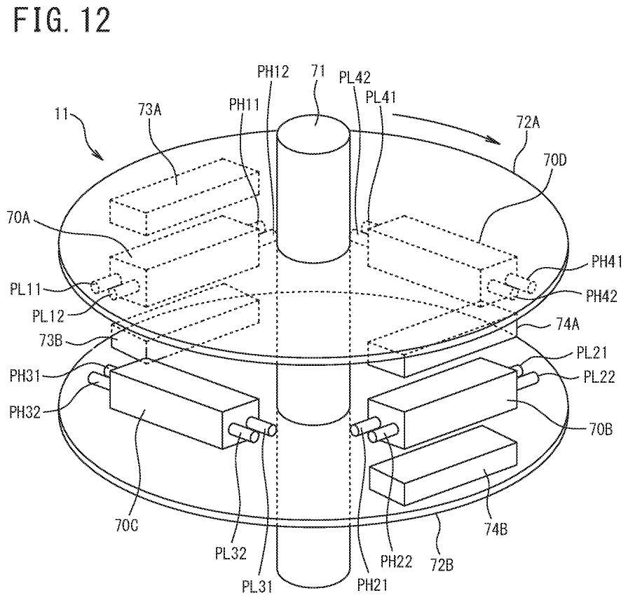

Furthermore, the heat pump body can be configured as illustrated in FIG. 12. More specifically, a configuration may be acceptable in which magnetic work bodies 70A and 70B formed into a rectangular parallelepiped shape are fixed at the 90° and 270° positions on the circumference sandwiching a rotation shaft 71, rotating disks 72A and 72B fixed to the rotation shaft 71 so as to sandwich the magnetic work bodies 70A to 70D in the vertical direction are disposed, and a pair of permanent magnets 73A and 73B and a pair of permanent magnets 74A and 74B are individually disposed on the facing surfaces at the 0° and 180° positions sandwiching the rotation shaft 71, for example, of the rotating disks 72A and 72B. In this case, the pair of upper permanent magnets 73A and 74A and the pair of lower permanent magnets 73B and 74B generate magnetic fluxes crossing the magnetic work bodies 70A to 70D in the vertical direction by setting the surfaces facing the magnetic work bodies of the permanent magnets 73A and 74A to the N pole (or S pole) and setting the other surfaces facing the magnetic work bodies of the permanent magnets 73B and 74B to the S pole (or N pole).

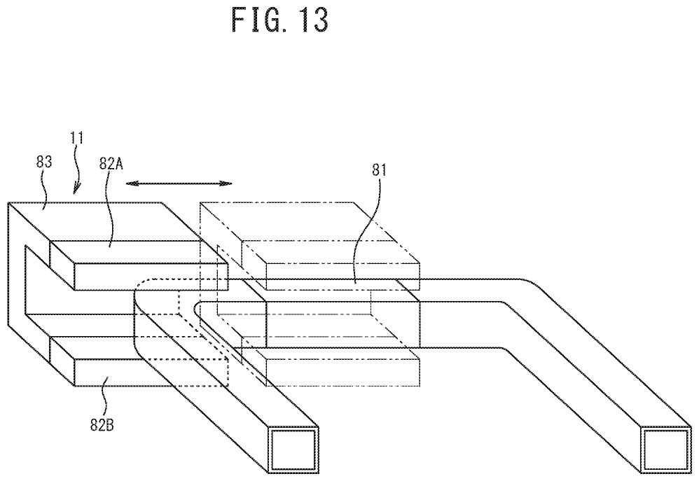

Moreover, the present invention is not limited to the case of rotating the permanent magnets as the magnetic heat pump device and can also be applied to a reciprocating magnetic heat pump device configured so that a magnetic work body 81 formed into a rectangular parallelepiped shape is fixed and disposed and a linear moving body 83, in which permanent magnets 82A and 82B generating magnetic fluxes crossing the magnetic work body 81 in the vertical direction, for example, are disposed so as to face each other, is linearly reciprocated between a position where the permanent magnets 82A and 82B face the magnetic work body 81 and a position where the permanent magnets 82A and 82B do not face the magnetic work body 81 as illustrated in FIG. 13.

### REFERENCE SIGNS LIST

10 magnetic heat pump device

11 heat pump body

12 high temperature side switching valve

13 heat dissipation side heat exchanger

14 heater

15 circulating pump

16 low temperature side switching valve

17 heat absorption side heat exchanger

21 rotor

22 stator

23 rotation shaft

24 support member

25A, 25B permanent magnet

26A to 26D hollow duct

27A to 27D magnetic work body unit

30A first magnetic work body

30B second magnetic work body

31 plate-shaped body

32 cut and raised piece

33 bent portion
51 bent body

52 cut and raised piece

53 bent portion

70A to 70D magnetic work body

71 rotation shaft

72A, 72B rotating disk

73A, 73B, 74A, 74B permanent magnet

81 magnetic work body

82A, 82B permanent magnet

83 linear moving body

1. A plate-shaped magnetic work body comprising:
a plate-shaped body formed of a magnetic work substance,
wherein a gap forming deformation portion serving as a gap adjusting member in laminating is formed in the plate-shaped body.

2. The plate-shaped magnetic work body according to claim 1,
wherein the gap forming deformation portion contains a plurality of cut and raised pieces individually formed in a width direction and a longitudinal direction of the plate-shaped body, and
the cut and raised pieces are disposed to be aligned in a flowing direction of a heat medium of the plate-shaped body.

3. The plate-shaped magnetic work body according to claim 1,
wherein the gap forming deformation portion contains the cut and raised pieces formed in at least three places of the plate-shaped body.

4. The plate-shaped magnetic work body according to claim 1,
wherein the gap forming deformation portion contains bent portions formed at least along facing sides of the plate-shaped body.

5. The plate-shaped magnetic work body according to claim 4,
wherein the bent portions are formed along a flow passage of a heat medium.

6. The plate-shaped magnetic work body according to claim 1,
wherein the plate-shaped body has a configuration in which two or more of the magnetic work substances different in a temperature zone where a high magnetocaloric effect is exhibited are arranged in one direction in such a manner that the temperature zones become high in order.

7. The plate-shaped magnetic work body according to claim 1,
wherein the magnetic work substance is any one of an Mn-based material and an La-based material.

8. The plate-shaped magnetic work body according to claim 1,
wherein the plate-shaped body is formed of a bent body.

9. A magnetic heat pump device comprising:
a magnetic work body unit in which two or more of the plate-shaped magnetic work bodies according to claim 1 are laminated while maintaining a gap formed by the gap forming deformation portion in a vessel in which a heat medium is made to flow;
a magnetic field changing mechanism configured to change a magnitude of a magnetic field applied to the magnetic work body of the magnetic work body unit;
a heat medium moving mechanism configured to move the heat medium between a high temperature end and a low temperature end of the magnetic work body unit;
a heat dissipation side heat exchanger configured to cause the heat medium on a side of the high temperature end to dissipate heat; and
a heat absorption side heat exchanger configured to cause the heat medium on a side of the low temperature end to absorb heat.

10. The plate-shaped magnetic work body according to claim 2,
wherein the plate-shaped body has a configuration in which two or more of the magnetic work substances different in a temperature zone where a high magnetocaloric effect is exhibited are arranged in one direction in such a manner that the temperature zones become high in order.

11. The plate-shaped magnetic work body according to claim 3,
wherein the plate-shaped body has a configuration in which two or more of the magnetic work substances different in a temperature zone where a high magnetocaloric effect is exhibited are arranged in one direction in such a manner that the temperature zones become high in order.

12. The plate-shaped magnetic work body according to claim 4,
wherein the plate-shaped body has a configuration in which two or more of the magnetic work substances different in a temperature zone where a high magnetocaloric effect is exhibited are arranged in one direction in such a manner that the temperature zones become high in order.

13. The plate-shaped magnetic work body according to claim 5,
wherein the plate-shaped body has a configuration in which two or more of the magnetic work substances different in a temperature zone where a high magnetocaloric effect is exhibited are arranged in one direction in such a manner that the temperature zones become high in order.

14. The plate-shaped magnetic work body according to claim 2,
wherein the magnetic work substance is any one of an Mn-based material and an La-based material.

15. The plate-shaped magnetic work body according to claim 4,
wherein the magnetic work substance is any one of an Mn-based material and an La-based material.

16. The plate-shaped magnetic work body according to claim 6,
wherein the magnetic work substance is any one of an Mn-based material and an La-based material.

17. The plate-shaped magnetic work body according to claim 3,
wherein the plate-shaped body is formed of a bent body.

18. The plate-shaped magnetic work body according to claim 5,
wherein the plate-shaped body is formed of a bent body.

19. The plate-shaped magnetic work body according to claim 7,
wherein the plate-shaped body is formed of a bent body.

20. A magnetic heat pump device comprising:
a magnetic work body unit in which two or more of the plate-shaped magnetic work bodies according to claim 6 are laminated while maintaining a gap formed by the gap forming deformation portion in a vessel in which a heat medium is made to flow;
a magnetic field changing mechanism configured to change a magnitude of a magnetic field applied to the magnetic work body of the magnetic work body unit;
a heat medium moving mechanism configured to move the heat medium between a high temperature end and a low temperature end of the magnetic work body unit;
a heat dissipation side heat exchanger configured to cause the heat medium on a side of the high temperature end to dissipate heat; and
a heat absorption side heat exchanger configured to cause the heat medium on a side of the low temperature end to absorb heat.
